(19) United States
(12) Patent Application Publication
(10) Pub. No.: US 2021/0229705 A1
(43) Pub. Date: Jul. 29, 2021

(54) VEHICLE CONTROLLER, VEHICLE CONTROLLING METHOD AND COMPUTER PROGRAM THEREFOR

(71) Applicant: Mazda Motor Corporation, Hiroshima (JP)

(72) Inventors: Yuta Tsuji, Aki-gun (JP); Akira Funakubo, Aki-gun (JP); Koji Kagami, Aki-gun (JP); Hitoshi Fukuba, Aki-gun (JP)

(73) Assignee: Mazda Motor Corporation, Hiroshima (JP)

(21) Appl. No.: 17/120,292

(22) Filed: Dec. 14, 2020

(30) Foreign Application Priority Data
Jan. 27, 2020 (JP) 2020-010759

(51) Int. Cl. B60W 60/00; B60W 30/06

(52) U.S. Cl. CPC B60W 60/0018; B60W 30/06; B60W 60/0016; B60W 2554/40; B60W 2540/26; B60W 2552/53; B60W 2554/20; B60W 2540/221

(57) ABSTRACT

In evacuation travel control, circuitry is configured to generate an evacuation route for evacuating the vehicle to the road shoulder area on the basis of road information and to control travel of the vehicle such that the vehicle travels on the evacuation route. The road information includes first information on a width of a road shoulder area along an end of the road in a width direction.

### CROSS REFERENCE TO RELATED APPLICATIONS

The present application contains subject matter related to Japanese Priority Application 2020-010759, filed in the Japanese Patent Office on Jan. 27, 2020, the entire contents of which being incorporated herein by reference in its entirety. The application also contains subject matter related to that described in U.S. application Ser. No. xx/xxx,xxx, having attorney docket number 15093US01, and claiming priority to JP 2020-010819; and U.S. application Ser. No. 17/120,290, having attorney docket number 15092US01, and claiming priority to JP 2020-010827; the entire contents of each of which being incorporated herein by reference in their entirety.

### TECHNICAL FIELD

A technique disclosed herein relates to a vehicle controller.

### BACKGROUND ART

In Patent document 1, an evacuation travel assistance system that is mounted on a vehicle is disclosed. This evacuation travel assistance system includes a driver determination unit, a notification unit, a reception unit, and an evacuation travel execution unit. The driver determination unit determines whether a driver of a host vehicle is in a state capable of driving normally. In the case where the driver determination unit determines that the driver is in a state incapable of driving normally, the notification unit notifies a center of location information, the center having a function of determining an evacuation destination on the basis of location information of the host vehicle and a function of transmitting the evacuation destination. The reception unit receives the evacuation destination that is transmitted from the center. The evacuation travel execution unit performs evacuation travel destined for the evacuation destination that is received by the reception unit.

### PRIOR ART DOCUMENTS

### Patent Documents

[Patent document 1] JP-A-2017-37464

### SUMMARY OF THE DISCLOSURE

### Problems to be Solved

However, when a road shoulder area along a road end set as an evacuation place does not have a sufficient width, a system as disclosed in Patent document 1 cannot appropriately evacuate the vehicle to the road shoulder area.

A technique disclosed herein has been made in view of such a point and therefore has a purpose of appropriately evacuating a vehicle to a road shoulder area.

### Means for Solving the Problems

A technique disclosed herein relates to a vehicle controller that controls the vehicle. This vehicle controller includes: a storage section that stores road information on a road ahead of the vehicle in an advancing direction; and a control section that executes evacuation travel control. The road information includes first information on a width of a road shoulder area along an end of the road in a width direction. In the evacuation travel control, the control section generates an evacuation route for evacuating the vehicle to the road shoulder area on the basis of the road information stored in the storage section, and controls travel of the vehicle such that the vehicle travels on the evacuation route.

In the above configuration, the evacuation route can be generated in consideration of the width of the road shoulder area. In this way, it is possible to appropriately evacuate the vehicle to the road shoulder area.

In the vehicle controller, the first information may include at least one of width information indicative of the width of the road shoulder area at each of plural observation points aligned in the advancing direction of the vehicle and static evaluation information indicative of a margin of the width of the road shoulder area at each of the plural observation points.

In the above configuration, the evacuation route can be generated in consideration of at least one of the width of the road shoulder area and a margin of the width thereof at each of the plural observation points. In this way, it is possible to appropriately evacuate the vehicle to the road shoulder area.

In the vehicle controller, the road information may include second information indicative of which portion of the road shoulder area the vehicle can be stopped in.

In the above configuration, it is possible to generate the evacuation route in consideration of which portion of the road shoulder area the vehicle can be stopped in. In this way, it is possible to appropriately evacuate the vehicle to the road shoulder area by avoiding a portion of the road shoulder area where the vehicle cannot be stopped.

In the vehicle controller, the second information may include at least one of obstacle information indicative of presence or absence of an obstacle in the road shoulder area at each of the plural observation points aligned in the advancing direction of the vehicle, road condition information indicative of whether the road shoulder area corresponds to a stopping permission area at each of the plural observation points, and mobile evaluation information indicative of whether the vehicle can be stopped in the road shoulder area at each of the plural observation points.

In the above configuration, it is possible to generate the evacuation route in consideration of at least one of the presence or the absence of the obstacle at each of the plural observation points, correspondence or non-correspondence of the stopping permission area at each of the plural observation points, and possibility or impossibility of stopping of the vehicle at each of the plural observation points. In this way, it is possible to appropriately evacuate the vehicle to the road shoulder area by avoiding the portion of the road shoulder area where the vehicle cannot be stopped.

In the vehicle controller, the control section recognizes external environment of the vehicle, generates the road information on the basis of a recognition result of the external environment, and stores the road information in the storage section.

In the above configuration, it is possible to generate the real-time road information on the basis of the recognition result of the external environment.

In the vehicle controller, the control section may be configured to execute the evacuation travel control when detecting an abnormal physical condition of a driver of the vehicle.

According to the above configuration, in the case where the abnormal physical condition of the driver of the vehicle is detected, the evacuation travel control is executed. Thus, in the case where the driver of the vehicle suffers from the abnormal physical condition, it is possible to appropriately evacuate the vehicle to the road shoulder area.

According to techniques disclosed herein, it is possible to appropriately evacuate the vehicle to the road shoulder area.

### BRIEF DESCRIPTION OF THE DRAWINGS

FIG. 1 is a block diagram exemplifying a configuration of the vehicle control system according to an embodiment.

FIG. 2 is a table exemplifying road information.

FIG. 3 is a schematic view for illustrating generation of the road information.

FIG. 4 is a flowchart for illustrating generation of road end information, outer line information, and width information.

FIG. 5 is a flowchart for illustrating operation of an evacuation control section in evacuation travel control.

FIG. 6 is a schematic view exemplifying setting of a search range in the evacuation travel control.

FIG. 7 is a schematic view exemplifying generation of the road information in the evacuation travel control.

FIG. 8 is a schematic view exemplifying a determination on appropriateness of an evacuation place in the evacuation travel control.

FIG. 9 is a schematic view exemplifying a change of the evacuation place in the evacuation travel control.

FIG. 10 is a block diagram of a computer-based system on which embodiments of the present system may be implemented.

### DETAILED DESCRIPTION

A detailed description will hereinafter be made on an embodiment with reference to the drawings. The same or corresponding portions in the drawings will be denoted by the same reference signs and numerals and the description thereon will not be repeated.

(Vehicle Control System)

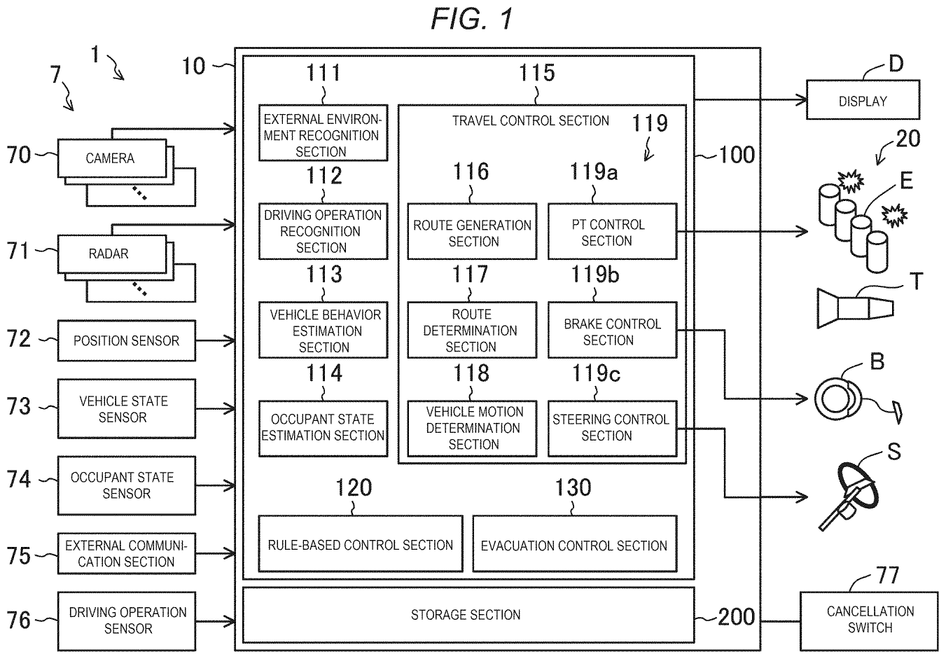

FIG. 1 exemplifies a configuration of a vehicle control system 1 according to the embodiment. The vehicle control system 1 is provided in a vehicle (more specifically, a four-wheeled motor vehicle). The vehicle can be switched among manual driving, assisted driving, and automated driving. The manual driving is driving in which the vehicle travels according to a driver's operation (for example, an operation of an accelerator pedal or the like). The assisted driving is driving in which the vehicle travels while the driver's operation is assisted. The automated driving is driving in which the vehicle travels without the driver's operation. The vehicle control system 1 controls the vehicle in the assisted driving and the automated driving. More specifically, the vehicle control system 1 controls operation (particularly, travel) of the vehicle by controlling an actuator 20 that is provided in the vehicle.

The vehicle control system 1 includes an information acquisition section 7 and a vehicle controller 10. In the following description, the vehicle that is provided with the vehicle control system 1 will be described as a “host vehicle”, and another vehicle that exists around the host vehicle will be described as the “other vehicle”.

[Actuator]

The actuator 20 includes an actuator for a drive system, an actuator for a steering system, an actuator for a brake system, and the like. Examples of the actuator for the drive system are an engine E, a transmission T, and a motor. An example of the actuator for the brake system is a brake B. An example of the actuator for the steering system is a steering wheel S.

[Information Acquisition Section]

The information acquisition section 7 acquires various types of information that are used for control of the vehicle. In this example, the information acquisition section 7 includes plural cameras 70, plural radars 71, a position sensor 72, a vehicle state sensor 73, an occupant state sensor 74, an external communication section 75, and a driving operation sensor 76.

<Camera>

The plural cameras 70 each have a similar configuration. The plural cameras 70 are provided to the vehicle such that image capturing areas of the plural cameras 70 surround the vehicle. The plural cameras 70 capture images of environment around the vehicle (external environment) and thereby acquire image data on the external environment. The image data that is acquired by each of the plural cameras 70 is transmitted to the vehicle controller 10. Each camera 31 may have an image sensor that takes fixed and/or moving images in the visual spectrum and/or non-visual ranges such as infrared and ultraviolet.

In this example, the camera 70 is a monocular camera having a wide-angle lens. For example, the camera 70 is configured by using solid-state imaging elements such as a charge-coupled device (CCD) and a complementary metal-oxide-semiconductor (CMOS). The camera 70 may be a monocular camera having a narrow-angle lens or a stereo camera having a wide-angle lens or a narrow-angle lens.

<Radar>

The plural radars 71 each have a similar configuration. The plural radars 71 are provided to the vehicle such that search areas of the plural radars 71 surround the vehicle. The plural radars 71 detect the external environment. More specifically, the radars 71 emit a search wave toward the external environment of the vehicle, receive a reflected wave from the external environment, and thereby detect the external environment. Detection results of the plural radars 71 are transmitted to the vehicle controller 10.

For example, the radar 71 may be a millimeter-wave radar that emits a millimeter wave, a short-range radar, SRR, operating, for example, in the 20 GHz to 27 GHz range, a long range radar, LRR, operating, for example, in the 76 to 81 GHz range, a lidar (light detection and ranging) that emits a laser beam, e.g., a laser beam having wavelengths in at least one of ultraviolet, visible, and near infrared spectrums, an infrared sensor that radiates infrared light, or an ultrasonic sensor that emits an ultrasonic wave, and the like.

<Position Sensor>

The position sensor 72 detects a location (for example, a latitude and a longitude) of the vehicle. For example, the position sensor 72 receives GPS information from the Global Positioning System and detects the location of the vehicle on the basis of the GPS information. The information (the location of the vehicle) that is acquired by the position sensor 72 is transmitted to the vehicle controller 10.

<Vehicle State Sensor>

The vehicle state sensor 73 detects a state (for example, a speed, acceleration, a yaw rate, and the like) of the vehicle. For example, the vehicle state sensor 73 includes: a vehicle speed sensor that detects the speed of the vehicle; an acceleration sensor that detects the acceleration of the vehicle; and a yaw rate sensor that detects the yaw rate of the vehicle. The information (the state of the vehicle) that is acquired by the vehicle state sensor 73 is transmitted to the vehicle controller 10.

<Occupant State Sensor>

The occupant state sensor 74 detects a state of the driver who drives the vehicle (for example, body behavior, biological information, and the like of the driver). The information (the state of the driver) that is acquired by the occupant state sensor 74 is transmitted to the vehicle controller 10. For example, the occupant state sensor 74 includes an in-vehicle camera, a biological information sensor, and the like. The in-vehicle camera is provided inside the vehicle. The in-vehicle camera acquires image data including the driver by capturing an image of an area including the driver. The image data that is acquired by the in-vehicle camera is transmitted to the vehicle controller 10. For example, the in-vehicle camera may be in front of the driver and set to have an imaging area where the driver's face is positioned within the imaging area. The biological information sensor detects the biological information (for example, sweating, heartbeats, a blood flow rate, a skin temperature, and the like) of the driver.

<External Communication Section>

The external communication section 75 receives information through an external network (for example, the Internet or the like) that is provided outside the vehicle. For example, the external communication section 75 receives communication information from the other vehicle) located around the vehicle, car navigation data from a navigation system), traffic information, and high-precision map information such as a dynamic map. The information that is acquired by the external communication section 75 is transmitted to the vehicle controller 10.

<Driving Operation Sensor>

The driving operation sensor 76 detects a driving operation on the vehicle. For example, the driving operation sensor 76 includes an accelerator pedal position sensor, a steering angle sensor, a brake hydraulic pressure sensor, and the like. The accelerator pedal position sensor detects an operation amount of the accelerator pedal of the vehicle. The steering angle sensor detects a steering angle of the steering wheel of the vehicle. The brake hydraulic pressure sensor detects an operation amount of the brake of the vehicle. The information (the vehicle driving operation) that is acquired by the driving operation sensor 76 is transmitted to the vehicle controller 10.

[Vehicle Controller]

The vehicle controller 10 is connected to the actuator 20 and each component (in this example, the information acquisition section 7 and the like) of the vehicle control system 1 in a manner capable of sending a signal thereto. The vehicle controller 10 controls the actuator 20 and each of the components of the vehicle control system 1 on the basis of the information that is acquired from each of the components of the vehicle control system 1.

In the assisted driving or the automated driving, the vehicle controller 10 determines a target route as a route on which the vehicle should travel, and controls operation of the actuator 20 such that the vehicle travels on the target route. For example, the vehicle controller 10 is constructed of one or plural electronic control units (ECUs). The electronic control unit may include a single integrated circuit (IC) or may include plural ICs. In the IC, a single core or die may be provided, or plural cooperative cores or dies may be provided. For example, the core or the die may include a processor (CPU) and memory that stores a program for operating the CPU and information such as a processing result of the CPU.

[Control Section]

The vehicle controller 10 includes a control section 100. The control section 100 controls the actuator 20 and each of the components of the vehicle control system 1 on the basis of the information that is acquired from each of the components of the vehicle control system 1. More specifically, the control section 100 controls the operation of the actuator 20 on the basis of the various types of the information that are acquired from the information acquisition section 7, and thereby controls the travel of the vehicle.

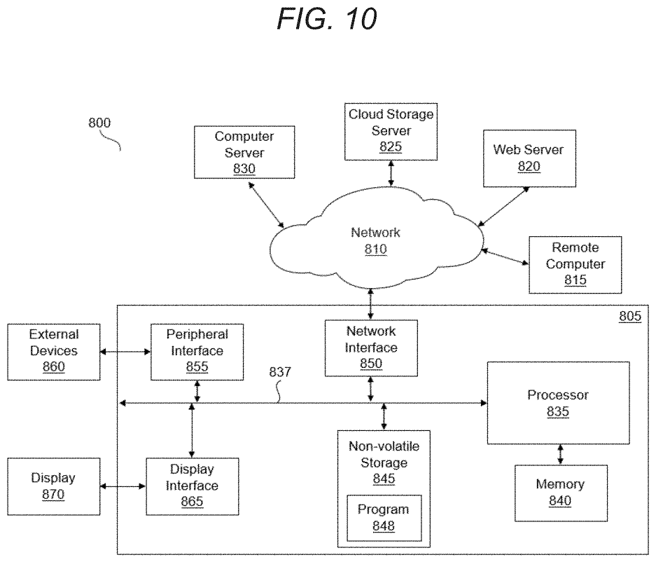

Optionally, the control section 100 may include a processor 835 and other circuitry in system 800 of FIG. 10, which may be implemented as a single processor-based system, or a distributed processor based system, including remote processing, such as cloud based processing.

In this example, the control section 100 detects presence or absence of an abnormal physical condition of the driver. Here, the abnormal physical condition means a state where a driving function of the driver is degraded due to a disease and it becomes difficult for the driver to keep driving the vehicle. Examples of such an abnormal physical condition are a brain disorder such as a cerebral stroke, a cardiac disorder such as myocardial infarction, epilepsy, and hypoglycemia.

The control section 100 executes normal travel control until the abnormal physical condition of the driver is detected. Then, when the abnormal physical condition of the driver is detected, the control section 100 stops the normal travel control and initiates evacuation travel control. In the normal travel control, the control section 100 selects the target route from plural route candidates, and controls the travel of the vehicle such that the vehicle travels on the target route. In the evacuation travel control, the control section 100 generates an evacuation route for evacuating the vehicle to a road shoulder area and controls the travel of the vehicle such that the vehicle travels on the evacuation route. A detailed description on the road shoulder area will be made below.

More specifically, the control section 100 has an external environment recognition section 111, a driving operation recognition section 112, a vehicle behavior estimation section 113, an occupant state estimation section 114, a travel control section 115, a rule-based control section 120, and an evacuation control section 130.

<Exterior Environment Recognition Section>

The external environment recognition section 111 recognizes the external environment of the vehicle on the basis of output of the plural cameras 70, output of the plural radars 71, output of the position sensor 72, output of the external communication section 75, and output of the vehicle behavior estimation section 113.

For example, the external environment recognition section 111 generates data on the external environment of the vehicle from the above output by using a learning model that is generated by deep learning. In the deep learning, a deep neural network is used. An example of the deep neural network is a convolutional neural network (CNN).

More specifically, the external environment recognition section 111 performs image processing on the image data that is acquired by the cameras 70 and/or the external communication section 75, and thereby generates road map data (for example, three-dimensional map data) on a road on which the vehicle can move. In addition, the external environment recognition section 111 acquires object information that is information on an object existing around the vehicle on the basis of the detection results of the radars 71 and/or the external communication section 75. The object information includes positional coordinates of the object, a speed of the object, and the like. Here, the external environment recognition section 111 may acquire the object information on the basis of the image data that is acquired from the cameras 70 and/or the external communication section 75. Then, the external environment recognition section 111 integrates the road map data and the object information, and thereby generates integrated map data (three-dimensional map data) on the external environment.

As described above, the integrated map data as output of the external environment recognition section 111 includes the road map data and the object information. The object information includes static object information and mobile object information.

The road map data includes information on a road shape, a road structure, a road gradient, a lane marking, a road surface marking, and the like. The road shape is represented by points or lines along road ends (ends of the road in a width direction). Examples of the road structure are an intersection, a diverging road, and a merging road. The lane marking is a line drawn on the road and extends in a stretching direction of the road. Examples of the lane marking are a roadway centerline, a roadway outer line, and a lane divider. The road surface markings are symbols and characters drawn and written on the road. Examples of the road surface marking are a crosswalk, a bicycle crossing lane, a safety zone, and a parking and stopping prohibition zone.

The static object information is information on a stationary object that is not displaced over time. The static object information includes information on a shape of the stationary object, positional coordinates of the stationary object, and the like. Examples of the stationary object are a road sign and a structure. Examples of the road sign are signs of the crosswalk, the bicycle crossing lane, the safety zone, and the parking and stopping prohibition zone. Examples of the structure are a traffic light, a median strip, a center pole, a building, a signboard, a level crossing, a tunnel, a railway track bed, and a bus stop.

The mobile object information is information on a mobile object that is possibly displaced over time. The mobile object information includes information on a shape of the mobile object, positional coordinates of the mobile object, a speed of the mobile object, and the like. Examples of the mobile object are another vehicle and a pedestrian.

The high-precision map information that is received by the external communication section 75 may include the road map data and the object information. In this case, the external environment recognition section 111 may be configured to generate the integrated map data on the basis of the road map data and the object information included in the high-precision map information and to appropriately correct the integrated map data on the basis of the output of the information acquisition section 7 including the plural cameras 70, the plural radars 71, and/or the external communication section 75. For example, in the case where the integrated map data does not include the object that is recognized on the basis of the output of the plural cameras 70, the output of the plural radars 71, and/or the external communication section 75, the external environment recognition section 111 may add the object information on the object to the integrated map data. Meanwhile, in the case where the object that is included in the integrated map data is not recognized on the basis of the output of the plural cameras 70, the output of the plural radars 71, and/or the external communication section 75, the external environment recognition section 111 may delete the object information on the object from the integrated map data.

<Driving Operation Recognition Section>

The driving operation recognition section 112 recognizes the driving operation on the vehicle on the basis of the output of the driving operation sensor 76. For example, the driving operation recognition section 112 generates data on the driving operation on the vehicle from the output of the driving operation sensor 76 by using a learning model that is generated by deep learning.

<Vehicle Behavior Estimation Section>

The vehicle behavior estimation section 113 estimates behavior (for example, the speed, the acceleration, the yaw rate, and the like) of the vehicle on the basis of the output of the vehicle state sensor 73. For example, the vehicle behavior estimation section 113 generates data on the behavior of the vehicle from the output of the vehicle state sensor 73 by using a learning model that is generated by deep learning.

For example, the learning model that is used by the vehicle behavior estimation section 113 is a vehicle six-axis model. In the vehicle six-axis model, the acceleration in three axial directions of “front/rear”, “right/left”, and “up/down” and angular velocities in three axial directions of “pitch”, “roll”, and “yaw” of the traveling vehicle are modeled. That is, the vehicle six-axis model is a numerical model that replicates the behavior of the vehicle by using a total of six axes including pitching (a Y-axis) and rolling (an X-axis) motion and movement in a Z-axis (vertical motion of a vehicle body) of the vehicle body placed on four wheels via suspensions instead of capturing motion of the vehicle only on a traditional vehicle dynamics plane (only front/rear and right/left (X-Y movement) and yaw motion (the Z-axis) of the vehicle).

<Occupant State Estimation Section>

The occupant state estimation section 114 estimates the state of the driver (for example, a health condition, a feeling, a posture, and the like of the driver) on the basis of output of the occupant state sensor 74. For example, the occupant state estimation section 114 generates data on the state of the driver from the output of the occupant state sensor 74 by using a learning model that is generated by deep learning. In this example, the occupant state estimation section 114 detects the abnormal physical condition of the driver. A well-known abnormality detection technique such as “Basic Design Specifications of Driver Abnormality Automated Detection System” developed by Ministry of Land, Infrastructure, Transport and Tourism of Japan can be used to detect the abnormal physical condition of the driver by the occupant state estimation section 114.

<Travel Control Section>

The travel control section 115 controls the actuator 20 on the basis of the output of the external environment recognition section 111, output of the driving operation recognition section 112, output of the vehicle behavior estimation section 113, and output of the occupant state estimation section 114. In this example, the travel control section 115 includes a route generation section 116, a route determination section 117, a vehicle motion determination section 118, and an actuator control section 119.

<<Route Generation Section>>

The route generation section 116 generates one or plural candidate routes on the basis of the output of the external environment recognition section 111. The candidate route is a route on which the vehicle can travel, and is a candidate for the target route. The candidate route may include a travel route that avoids an obstacle (the object) recognized by the external environment recognition section 111 and that is present on the road recognized by the external environment recognition section 111.

For example, based on the output (the integrated map data representing the external environment) of the external environment recognition section 111, the route generation section 116 generates travel map data (two-dimensional map data) that includes the road ahead of the vehicle in an advancing direction and the object existing on the road. Then, the route generation section 116 generates the candidate route by using a state lattice method. More specifically, the route generation section 116 sets a grid area including a large number of grid points on the road in the travel map data, and sequentially connects the plural grid points in the advancing direction of the vehicle, so as to set plural travel routes. In addition, the route generation section 116 adds route cost for each of the plural travel routes. For example, as safety of the vehicle on a certain travel route is increased, the route cost that is added to such a travel route is reduced. Then, based on the route cost that is added to each of the plural travel routes, the route generation section 116 selects, as the candidate route, one or plural travel routes from the plural travel routes.

<<Route Determination Section>>

The route determination section 117 selects the candidate route that serves as the target route from the one or plural candidate routes generated by the route generation section 116, the rule-based control section 120, and the evacuation control section 130 on the basis of the output of the driving operation recognition section 112 and the output of the occupant state estimation section 114. For example, the route determination section 117 selects the candidate route that the driver feels as the most comfortable of the plural candidate routes.

For example, in the normal travel control, the route determination section 117 preferentially selects, as the target route, the candidate route generated by the route generation section 116 over the candidate route generated by the rule-based control section 120. Alternatively, in the normal travel control, in the case where the candidate route generated by the route generation section 116 significantly deviates from the candidate route generated by the rule-based control section 120, the route determination section 117 may select, as the target route, the candidate route generated by the rule-based control section 120. For example, in the case where the travel route generated by the route generation section 116 does not run through a free space that is searched by the rule-based control section 120, the route determination section 117 may determine that the candidate route generated by the route generation section 116 significantly deviates from the candidate route generated by the rule-based control section 120. The free space is an area of the road where the obstacle does not exist. Examples of the obstacle are a mobile obstacle and a static obstacle. Examples of the mobile obstacle are another vehicle and the pedestrian. Examples of the static obstacle are the median strip and the center pole.

In addition, in the evacuation travel control, the route determination section 117 selects, as the target route, the evacuation route generated by the evacuation control section 130. A detailed description on the evacuation route will be made below.

<<Vehicle Motion Determination Section>>

The vehicle motion determination section 118 determines target motion on the basis of the candidate route (or the evacuation route) selected by the route determination section 117 as the target route. This target motion is motion of the vehicle that is required to travel on the target route. In this example, the vehicle motion determination section 118 derives target drive power, a target braking force, and a target steering amount that are drive power, a braking force, and a steering amount required to generate the target motion, respectively. For example, the vehicle motion determination section 118 calculates the motion of the vehicle on the target route on the basis of the vehicle six-axis model and determines the target motion on the basis of the calculation result.

<<Actuator Control Section>>

The actuator control section 119 controls the actuator 20 on the basis of the target motion that is determined by the vehicle motion determination section 118. In this example, the actuator control section 119 has a powertrain (PT) control section 119a, a brake control section 119b, and a steering control section 119c. The PT control section 119a transmits a drive command value indicative of the target drive power to the actuator for the drive system. The brake control section 119b transmits a brake command value indicative of the target braking force to the actuator for the brake system. The steering control section 119c transmits a steering command value indicative of the target steering amount to the actuator for the steering system.

<Rule-Based Control Section>

The rule-based control section 120 uses an algorithm, which is based on a predetermined rule, for processing instead of a learning model generated by deep learning.

More specifically, the rule-based control section 120 recognizes the exterior environment on the basis of the output of the information acquisition section 7 and searches the exterior environment for the free space. For example, the rule-based control section 120 searches for the free space on the basis of a search rule that is set in advance. The search rule may include such a rule that a specified range with the object being a center (for example, a range of several meters) is set as unavoidable range. In addition, the rule-based control section 120 may be configured to search for the free space in consideration of a moving speed of the mobile object in the case where the object is the mobile object.

Then, the rule-based control section 120 generates the candidate route that runs through the free space (that is, the candidate route that avoids the obstacle). The candidate route that is generated by the rule-based control section 120 (that is, the candidate route that runs through the free space) is used by the route determination section 117 in the travel control section 115.

<Evacuation Control Section>

The evacuation control section 130 generates road information 30. In addition, in the evacuation travel control, the evacuation control section 130 sets an evacuation place, generates the evacuation route, and searches for the free space. A detailed description on the road information 30 and operation of the evacuation control section 130 will be made below.

[Storage Section]

The vehicle controller 10 includes a storage section 200. The storage section 200 includes a memory that stores the various types of the information. In addition, the storage section 200 stores the road information 30 that is generated by the evacuation control section 130 and/or road information received from external devices.

[Road Information]

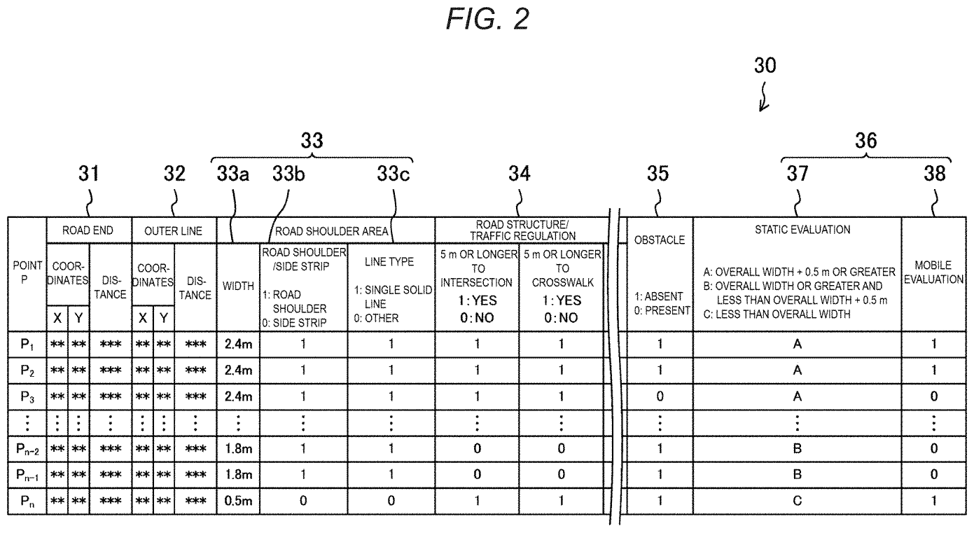

Next, a description will be made on the road information 30 with reference to FIG. 2. The road information 30 is information on the road ahead of the vehicle in the advancing direction. As illustrated in FIG. 2, the road information 30 includes road end information 31, outer line information 32, road shoulder area information 33, road condition information 34, obstacle information 35, and evaluation information 36. The evaluation information 36 includes static evaluation information 37 and mobile evaluation information 38.

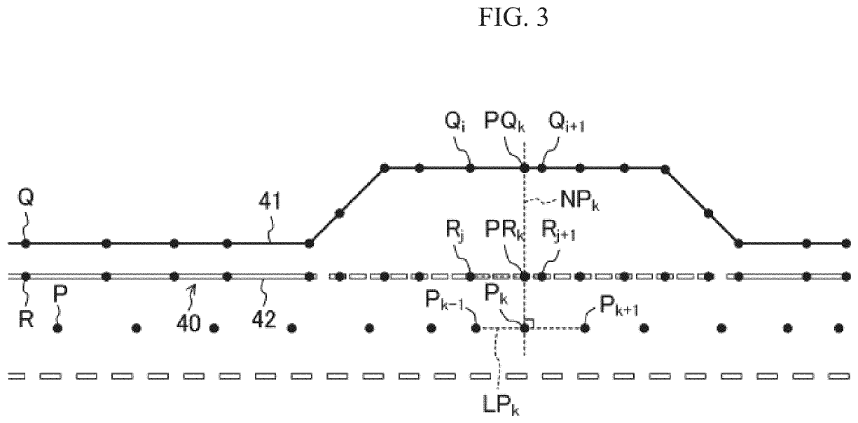

In the road information 30, information is registered for each of plural observation points P. In the example illustrated in FIG. 2, the information is registered for each of the number n of observation points P₁ to Pₙ. Here, n is an integer that is equal to or larger than two. As illustrated in FIG. 3, the plural observation points P are imaginary points that are aligned in the advancing direction of the vehicle on the road ahead of the vehicle in the advancing direction. In the example illustrated in FIG. 3, the plural observation points P are aligned along a center of a lane that is adjacent to a road end 41 (for example, a first travel lane in the case where plural lanes are present).

<Road End Information>

The road end information 31 is information on the road end. As illustrated in FIG. 3, the road end 41 is an end or edge of the road in a width direction. The width direction of the road is an orthogonal direction to the stretching direction of the road, i.e., a direction of travel. The stretching direction of the road is a direction along the advancing direction of the vehicle on the road.

As illustrated in FIG. 2, the road end information 31 indicates coordinates of the road end 41 and a distance to the road end 41 at each of the plural observation points P. The coordinates of the road end 41 are coordinates in an SL coordinate system that has a direction along a center of the road as an S-axis direction and an orthogonal direction to the direction along the center of the road as an L-axis direction. The S-axis direction corresponds to the stretching direction of the road, and the L-axis direction corresponds to the width direction of the road. “X” of the coordinates represents a value in the S-axis, and “Y” thereof represents a value in the L-axis.

More specifically, the coordinates of the road end 41 at the k-th number of the observation point Pₖ indicate coordinates of an intersection point of the road end 41 with a normal NPₖ that passes the k-th number of the observation point Pₖ and extends in the width direction of the road. The distance from the k-th number of the observation point Pₖ to the road end 41 corresponds to a distance from the k-th number of the observation point Pₖ to the above intersection point. Here, k is an integer that is equal to or larger than 1 and equal to or smaller than n.

<Outer Line Information>

The outer line information 32 is information on an outer line of the road on which the host vehicle travels. As illustrated in FIG. 3, an outer line 42 is a lane marking that is the closest to the road end 41 of the lane markings drawn on the road (lines along the stretching direction of the road). For example, the outer line 42 is a roadway outer line and is a lane marking on an outer side (a left side in the case of left-hand traffic) of the first travel lane.

As illustrated in FIG. 2, the outer line information 32 indicates coordinates of the outer line 42 and a distance to the outer line 42 at each of the plural observation points P. The coordinates of the outer line 42 are coordinates in the SL coordinate system.

More specifically, the coordinates of the outer line 42 at the k-th number of the observation point Pₖ indicate coordinates of an intersection point of the outer line 42 with the normal NPₖ that passes the k-th number of the observation point Pₖ and extends in the width direction of the road. The distance from the k-th number of the observation point Pₖ to the outer line 42 corresponds to a distance from the k-th number of the observation point Pₖ to the above intersection point.

<Road Shoulder Area Information>

The road shoulder area information 33 is information on the road shoulder area. As illustrated in FIG. 3, a road shoulder area 40 is an area along the road end 41. More specifically, the road shoulder area 40 is an area between the road end 41 and the outer line 42.

As illustrated in FIG. 2, the road shoulder area information 33 includes width information 33a, classification information 33b, and line type information 33c.

<<Width Information>>

The width information 33a is information on a width of the road shoulder area 40. The width of the road shoulder area 40 is a length of the road shoulder area 40 in the width direction of the road. The width information 33a indicates the width of the road shoulder area 40 at each of the plural observation points P. The width information 33a is an example of the first information. The first information is information on the width of the road shoulder area 40.

<<Classification Information>>

The classification information 33b is information on a classification of the road shoulder area 40. The classification information 33b indicates the classification of the road shoulder area 40 at each of the plural observation points P. The classification information 33b is an example of the second information. The second information is information on which portion of the road shoulder area 40 the vehicle can be parked.

In this example, in the case where the classification of the road shoulder area 40 is a “road shoulder”, “1” is registered in the classification information 33b. In the case where the classification of the road shoulder area 40 is a “side strip”, “0” is registered in the classification information 33b. In this specification, the side strip is a side strip where parking of the vehicle is prohibited. Examples of such side strip are a parking/stopping prohibition side strip and a pedestrian side strip. The road shoulder is the road shoulder area 40 other than the side strips as described above. For example, the road shoulder is an area between a left sidewalk of the road and the roadway outer line. In this specification, the side strip where the vehicle can be parked is included in the road shoulder.

<<Line Type Information>>

The line type information 33c is information on a type of the lane marking (a line drawn on the road) that defines the road shoulder area 40. The line type information 33c indicates the type of the lane marking that defines the road shoulder area 40 at each of the plural observation points P. The line type information 33c is an example of the second information.

In this example, in the case where the type of the lane marking that defines the road shoulder area 40 is a “single solid line”, “1” is registered in the line type information 33c. In the case where the type of the lane marking that defines the road shoulder area 40 is “other”, “0” is registered in the line type information 33c. For example, a lane marking that defines the side strip (an example of the road shoulder) where the vehicle can be stopped is a single solid line (white line). A lane marking that defines the parking/stopping prohibition side strip includes a single solid line and a single broken line that are parallel in the width direction of the vehicle. A lane marking that defines the pedestrian side strip includes two solid lines that are parallel in the width direction of the road.

<Road Condition Information>

The road condition information 34 is information on a road condition. The road condition is a condition for determining whether the road shoulder area 40 corresponds to a stopping permission area. For example, the road conditions include a condition on a road structure, a condition on a traffic regulation, and the like. The road condition information 34 indicates, at each of the plural observation points P, whether the road shoulder area 40 corresponds to the stopping permission area. The road condition information 34 is an example of the second information.

In this example, plural items are included in the road condition information 34. A stopping permission condition, which is the condition that the road shoulder area 40 corresponds to the stopping permission area, is assigned to each of the plural items. Then, each of the plural items indicates whether the road shoulder area 40 satisfies the stopping permission condition. More specifically, in the case where the road shoulder area 40 satisfies the stopping permission condition that is assigned to a certain item, “0” is registered for such an item. In the case where the road shoulder area 40 does not satisfy the stopping permission condition that is assigned to a certain item, “1” is registered for such an item.

Examples of the stopping permission condition that is assigned to each of the items included in the road condition information 34 are as follows.

(1) A condition that a distance from the observation point P to an intersection is 5 m or longer

(2) a condition that a distance from the observation point P to a crosswalk is 5 m or longer

(3) a condition that a distance from the observation point P to a bicycle crossing lane is 5 m or longer

(4) a condition that a distance from the observation point P to a final end of the road in the advancing direction is 5 m or longer

(5) a condition that a distance from the observation point P to a diverging road is equal to or longer than a specified distance

(6) a condition that a distance from the observation point P to a merging road is equal to or longer than a specified distance

(7) a condition that a distance from the observation point P to a level crossing is 10 m or longer

(8) a condition that a gradient of the road at the observation point P is equal to or smaller than a specified gradient

(9) a condition that the observation point P is located outside a tunnel

(10) a condition that the observation point P is located outside a railway track bed

(11) a condition that a distance from the observation point P to a bus stop is 10 m or longer

(12) a condition that a distance from the observation point P to a safety zone is 10 m or longer

(13) a condition that the observation point P is located outside a parking and stopping prohibition zone

The conditions so far are examples of the condition that is satisfied by the road shoulder area 40 at the observation point P corresponding to the stopping permission area. The distances such as “5 m” and “10 m” described above are examples of the specified distance. The specified distance and the specified gradient described above may be set on the basis of the Road Traffic Act or the like.

<Obstacle Information>

The obstacle information 35 indicates presence or absence of the obstacle in the road shoulder area 40 at each of the observation points P. The obstacle information 35 is an example of the second information. Examples of the obstacle are another vehicle and a utility pole.

In this example, in the case where the obstacle is absent in the road shoulder area 40, “1” is registered in the obstacle information 35. In the case where the obstacle is present in the road shoulder area 40, “0” is registered in the obstacle information 35.

<Static Evaluation Information>

The static evaluation information 37 indicates a margin of the width of the road shoulder area 40 at each of the plural observation points P. The static evaluation information 37 is an example of the first information. As the margin of the width of the road shoulder area 40 is increased, adequacy of parking on the road shoulder in the road shoulder area 40 is increased.

In this example, the margin of the width of the road shoulder area 40 is evaluated on a three-point scale. More specifically, in the case where the width of the road shoulder area 40 is greater than an “overall width of the vehicle+0.5 m”, “A” as the highest evaluation value is registered in the static evaluation information 37. In the case where the width of the road shoulder area 40 is equal to or greater than the “overall width of the vehicle” and is less than the “overall width of the vehicle+0.5 m”, “B” as the second highest evaluation value is registered in the static evaluation information 37. In the case where the width of the road shoulder area 40 is less than the “overall width of the vehicle”, “C” as the lowest evaluation value is registered in the static evaluation information 37. Here, the length “0.5 m” is an example of a reference length used to determine the margin of the width of the road shoulder area 40.

<Mobile Evaluation Information>

The mobile evaluation information 38 indicates whether the vehicle can be stopped in the road shoulder area 40 at each of the plural observation points P. The mobile evaluation information 38 is an example of the second information.

In this example, in the case where the vehicle can be stopped in the road shoulder area 40, “1” is registered in the mobile evaluation information 38. In the case where the vehicle cannot be stopped in the road shoulder area 40, “0” is registered in the mobile evaluation information 38.

More specifically, an evaluation value (1 or 0) that is registered in the mobile evaluation information 38 at the k-th number of the observation point Pₖ is a product of an identification value (1 or 0) that is registered in each of the plural items included in the road condition information 34 at the k-th number of the observation point Pₖ and an identification value (1 or 0) that is registered in the obstacle information 35 at the k-th number of the observation point Pₖ.

[Generation of Road Information]

Next, a description will be made on generation of the road information 30. The control section 100 recognizes the external environment of the vehicle, generates the road information 30 on the basis of a recognition result of the external environment, and stores the road information 30 in the storage section 200. More specifically, the evacuation control section 130 generates the road information 30 as follows.

First, based on the output (the integrated map data representing the external environment) of the external environment recognition section 111, the evacuation control section 130 generates travel map data (two-dimensional map data) that includes the road ahead of the vehicle in the advancing direction and the object existing on the road. The evacuation control section 130 may not generate the travel map data, in which case the travel map data generated by the route generation section 116 may be used.

Next, the evacuation control section 130 sets the plural observation points P (the imaginary points), which are aligned in the advancing direction of the vehicle, on the road in the travel map data. In this example, in order to generate information on each of the number n of the observation points P₁ to Pₙ, the number of n+2 of observation points P₀ to Pₙ₊₁ from the “observation point P₀ that is located in front of the first observation point P₁” to the “observation point Pₙ₊₁ that is located behind the n-th number of the observation point Pₙ” are set. The number n+2 of the observation points P₀ to Pₙ₊₁ are aligned at equally-spaced intervals along a center of a roadway that is adjacent to the road end 41.

Next, the evacuation control section 130 generates the information on each of the number n of the observation points P₁ to Pₙ (in this example, the road end information 31, the outer line information 32, the road shoulder area information 33, the road condition information 34, the obstacle information 35, and the evaluation information 36) on the basis of the various types of the information that are included in the integrated map data as the output of the external environment recognition section 111. Then, the evacuation control section 130 stores various types of the information on each of the number n of the observation points P₁ to Pₙ in the storage section 200.

[Generation of Road End Information, Outer Line Information, and Width Information]

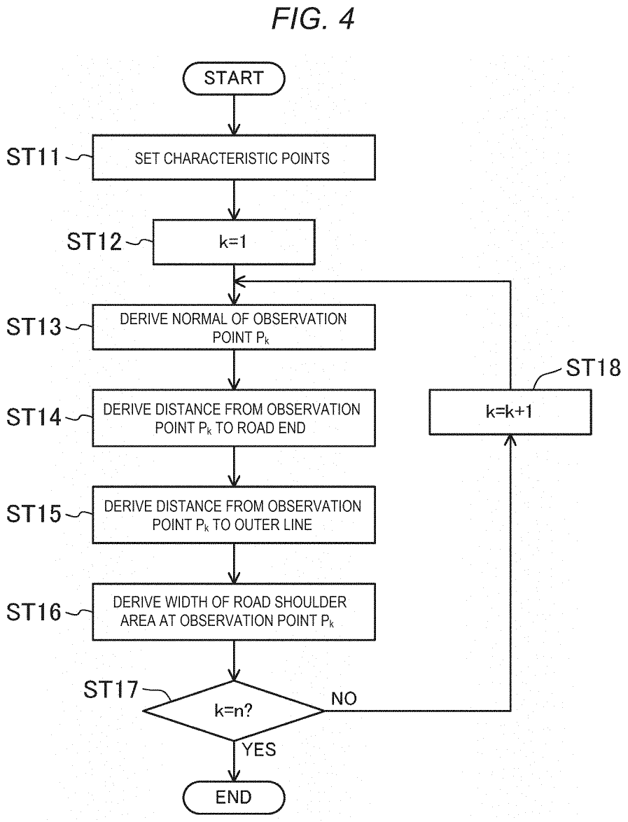

Next, a description will be made on the generation of the road end information 31, the outer line information 32, and the width information 33a with reference to FIG. 3 and FIG. 4.

<Step ST11>

First, the evacuation control section 130 sets plural characteristic points Q that are aligned along the road end 41 of the road presented in the travel map data. The evacuation control section 130 also sets plural characteristic points R that are aligned along the outer line 42 of the road presented in the travel map data.

<Step ST12>

Next, the evacuation control section 130 selects the first observation point P₁ as a processing target. In this way, the k-th number of the observation point Pₖ as the processing target is set as the first observation point P₁. That is, the variable k is set to 1.

<Step ST13>

The evacuation control section 130 derives the k-th number of an approximate straight line LPₖ that is an approximate straight line connecting the k-th number of the observation point P₁ with the k−1-th number of the observation point Pₖ₋₁ and the k+1-th number of the observation point Pₖ₊₁, each of which is next to the observation point Pₖ. Then, the evacuation control section 130 derives the k-th number of the normal NPₖ that passes the k-th number of the observation point Pₖ and is orthogonal to the approximate straight line LPₖ.

<Step ST14>

The evacuation control section 130 extracts the i-th number of the characteristic point Qᵢ and the i+1-th number of the characteristic point Qᵢ₊₁, each of which is next to the k-th number of the normal NPₖ, from the plural characteristic points Q. Next, the evacuation control section 130 calculates the k-th number of an intersection point PQₖ that is an intersection point of the k-th number of the normal NPₖ and a straight line connecting the i-th number of the characteristic point Q. and the i+1-th number of the characteristic point Qᵢ₊₁. Then, the evacuation control section 130 sets a length of a straight line that connects the k-th number of the observation point Pₖ and the k-th number of the intersection point PQₖ as the distance from the k-th number of the observation point Pₖ to the road end 41. In this way, the distance from the k-th number of the observation point Pₖ to the road end 41 is derived.

<Step ST15>

The evacuation control section 130 extracts the j-th number of the characteristic point Rⱼ and the j+1-th number of the characteristic point Rⱼ₊₁, each of which is next to the k-th number of the normal NPₖ, from the plural characteristic points R. Next, the evacuation control section 130 calculates the k-th number of an intersection point PRₖ that is an intersection point of the k-th number of the normal NPₖ and a straight line connecting the j-th number of the characteristic point Rⱼ and the j+1-th number of the characteristic point Rⱼ₊₁. Then, the evacuation control section 130 sets a length of a straight line that connects the k-th number of the observation point Pₖ and the k-th number of the intersection point PRₖ as the distance from the k-th number of the observation point Pₖ to the outer line 42. In this way, the distance from the k-th number of the observation point Pₖ to the outer line 42 is derived.

<Step ST16>

Next, the evacuation control section 130 sets, as the width of the road shoulder area 40 at the k-th number of the observation point Pₖ, a distance that is acquired by subtracting the “distance from the k-th number of the observation point Pₖ to the outer line 42” derived in step ST15 from the “distance from the k-th number of the observation point Pₖ to the road end 41” derived in step ST14. In this way, the width of the road shoulder area 40 at the k-th number of the observation point Pₖ is derived.

<Step ST17>

Next, the evacuation control section 130 determines whether the k-th number of the observation point Pₖ as the processing target is the n-th number of the observation point Pₙ. That is, the evacuation control section 130 determines whether the variable k is n. If the k-th number of the observation point Pₖ as the processing target is the n-th number of the observation point Pₙ, the processing is terminated. If not, processing in step ST18 is executed.

<Step ST18>

If the k-th number of the observation point Pₖ is not the n-th number of the observation point Pₙ, the evacuation control section 130 selects the k+1-th number of the observation point Pₖ₊₁, which is subsequent to the k-th number of the observation point Pₖ, as a target of the next processing. Then, processing in steps ST13 to ST17 are executed again.

[Generation of Classification Information and Line Type Information]

Next, a description will be made on generation of the classification information 33b and the line type information 33c. In the following description, a portion of the road shoulder area 40 that crosses the normal NPₖ passing the k-th number of the observation point Pₖ and extending in the width direction of the roadway will be described as the “road shoulder area 40 at the k-th number of the observation point Pₖ”.

The evacuation control section 130 detects the classification of the road shoulder area 40 at each of the number n of the observation points P₁ to Pₙ and the type of the lane marking that defines the road shoulder area 40 on the basis of the information on the lane marking included in the integrated map data. Then, based on those detection results, the evacuation control section 130 generates the classification information 33b and the line type information 33c at each of the number n of the observation points P₁ to Pₙ.

For example, in the case where the lane marking that defines the road shoulder area 40 at the k-th number of the observation point Pₖ is the “single solid line”, the evacuation control section 130 registers “1” in the classification information 33b at the k-th number of the observation point Pₖ and registers “1” in the line type information 33c at the k-th number of the observation point Pₖ.

[Generation of Road Condition Information]

Next, a description will be made on generation of the road condition information 34. The evacuation control section 130 detects the structure and the traffic regulation of the road ahead of the vehicle in the advancing direction on the basis of the various types of the information included in the integrated map data. Then, based on those detection results, the evacuation control section 130 generates the road condition information 34 at each of the number n of the observation points P₁ to Pₙ.

For example, based on the information on the road structure included in the integrated map data, the evacuation control section 130 detects the intersection of the road ahead of the vehicle in the advancing direction, the final end of the road in the advancing direction, the diverging road, the merging road, and the like. In addition, based on the information on the road gradient included in the integrated map data, the evacuation control section 130 detects the gradient of the road ahead of the vehicle in the advancing direction. Furthermore, based on the information on the road surface marking and the information on the road sign included in the integrated map data, the evacuation control section 130 detects the crosswalk, the bicycle crossing lane, the safety zone, the parking and stopping prohibition zone, and the like of the road ahead of the vehicle in the advancing direction. Moreover, based on the information on the structure included in the integrated map data, the evacuation control section 130 detects the level crossing, the tunnel, the railway track bed, and the bus stop ahead of the vehicle in the advancing direction.

Next, based on the detection result of the intersection (the crosswalk, the bicycle crossing lane, the final end of the road in the advancing direction, the diverging road, the merging road, the level crossing, the bus stop, or the safety zone), the evacuation control section 130 determines whether a distance from the observation point P to the intersection (the crosswalk, the bicycle crossing lane, the final end of the road in the advancing direction, the diverging road, the merging road, the level crossing, the bus stop, or the safety zone) satisfies a condition that such a distance is equal to or longer than a specified distance for each of the number n of the observation points P₁ to Pₙ. In addition, based on the detection result of the road gradient, the evacuation control section 130 determines whether the road gradient at the observation point P satisfies a condition that such a road gradient is equal to or smaller than the specified gradient for each of the number n of the observation points P₁ to Pₙ. Furthermore, based on the detection result of the tunnel (the railway track bed or the parking and stopping prohibition zone), the evacuation control section 130 determines whether the observation point P satisfies a condition that such an observation point P is located outside the tunnel (the railway track bed or the parking and stopping prohibition zone) for each of the number n of the observation points P₁ to Pₙ.

Then, based on the determination results described so far, the evacuation control section 130 registers “1” or “0” in each of the plural items included in the road condition information 34.

[Generation of Obstacle Information]

Next, a description will be made on generation of the obstacle information 35. The evacuation control section 130 detects the presence or the absence of the object in the road shoulder area 40 at each of the number n of the observation points P₁ to Pₙ on the basis of the object information included in the integrated map data. Then, based on the detection result, the evacuation control section 130 generates the obstacle information 35 at each of the number n of the observation points P₁ to Pₙ.

For example, in the case where the object does not exist in the road shoulder area 40 at the k-th number of the observation point Pₖ, the evacuation control section 130 registers “1” in the obstacle information 35 at the k-th number of the observation point Pₖ. In the case where the object exists in the road shoulder area 40 at the k-th number of the observation point Pₖ, the evacuation control section 130 registers “0” in the obstacle information 35 at the k-th number of the observation point Pₖ.

[Generation of Static Evaluation Information]

Next, a description will be made on generation of the static evaluation information 37. The evacuation control section 130 acquires information on the width of the vehicle, and generates the static evaluation information 37 at each of the number n of the observation points P₁ to Pₙ on the basis of the width information 33a and the width of the vehicle at each of the number n of the observation points P₁ to Pₙ. The information on the width of the vehicle may be stored in the storage section 200.

For example, in the case where it is assumed that the width of the vehicle is “1.8 m”, and the width of the road shoulder area 40 indicated by the width information 33a at the k-th number of the observation point Pₖ is equal to or greater than “2.3 m”, the evacuation control section 130 registers “A” in the static evaluation information 37 at the k-th number of the observation point Pₖ. In the case where the width of the road shoulder area 40 indicated by the width information 33a at the k-th number of the observation point Pₖ is less than “2.3 m” and equal to or greater than “1.8 m”, the evacuation control section 130 registers “B” in the static evaluation information 37 at the k-th number of the observation point Pₖ. In the case where the width of the road shoulder area 40 indicated by the width information 33a at the k-th number of the observation point Pₖ is less than “1.8 m”, the evacuation control section 130 registers “C” in the static evaluation information 37 at the k-th number of the observation point Pₖ.

[Generation of Mobile Evaluation Information]

Next, a description will be made on generation of the mobile evaluation information 38. The evacuation control section 130 generates the mobile evaluation information 38 at each of the number n of the observation points P₁ to Pₙ on the basis of the road condition information 34 and the obstacle information 35 at each of the number n of the observation points P₁ to Pₙ.

For example, in the case where “1” is registered in each of the plural items included in the road condition information 34 at the k-th number of the observation point Pₖ, and “1” is registered in the obstacle information 35 at the k-th number of the observation point Pₖ, the evacuation control section 130 registers “1” in the mobile evaluation information 38 at the k-th number of the observation point Pₖ. In the case where “0” is registered at least one in the plural items included in the road condition information 34 at the k-th number of the observation point Pₖ and the obstacle information 35 at the k-th number of the observation point Pₖ, the evacuation control section 130 registers “0” in the mobile evaluation information 38 at the k-th number of the observation point Pₖ.

[Operation of Evacuation Control Section in the Evacuation Travel Control]

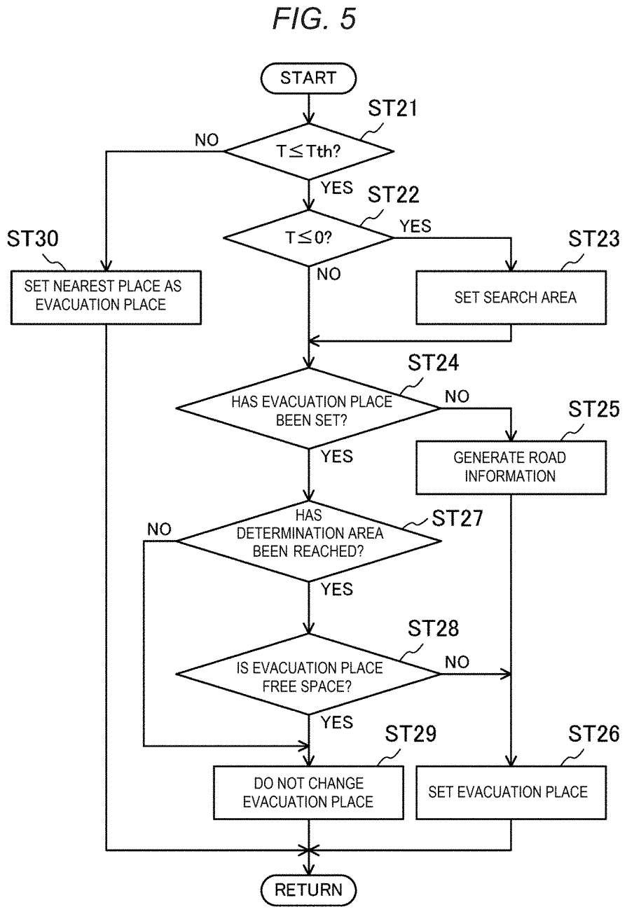

Next, a description will be made on operation of the evacuation control section 130 in the evacuation travel control with reference to FIG. 5. In this example, when the abnormal physical condition of the driver is detected, the evacuation travel control is initiated. In the evacuation travel control, the evacuation control section 130 repeatedly executes the following processing in predetermined cycles.

<Step ST21>

First, the evacuation control section 130 determines whether an elapsed time T from an initiation time point of the evacuation travel control is equal to or longer than a predetermined limited time Tth. If the elapsed time T is equal to or longer than the limited time Tth, processing in step ST22 is executed. If not, processing in step ST30 is executed. For example, the limited time Tth may be set to an upper limit time (more specifically, 180 seconds) that is defined in “Basic Design Specifications of Driver Abnormality Handling System (Road Shoulder Evacuation Type)” developed by Ministry of Land, Infrastructure, Transport and Tourism of Japan.

<Step ST22>

The evacuation control section 130 determines whether the elapsed time T is equal to or less than zero. If the elapsed time T is equal to or less than zero, processing in step ST23 is executed. If not, processing in step ST24 is executed.

<Step ST23>

The evacuation control section 130 sets a search range 50 on the road in the travel map data. The search range 50 is a range where an evacuation place 60, which will be described below, should be searched. For example, the evacuation control section 130 sets the search range 50 in consideration of a travel distance that is required for evacuation preparation of the host vehicle toward the road shoulder area 40.

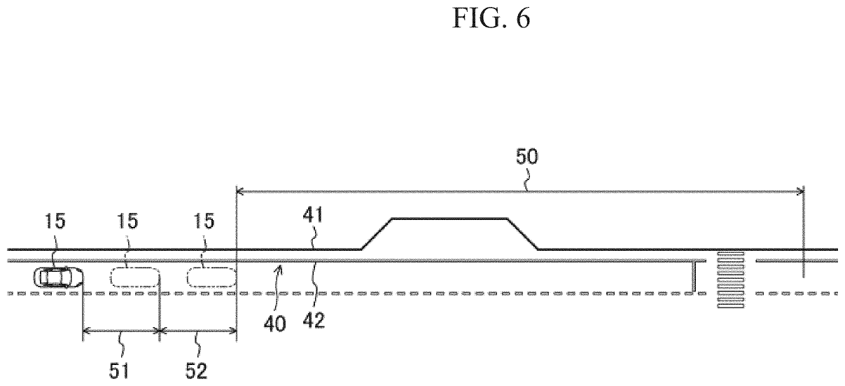

For example, as illustrated in FIG. 6, the evacuation control section 130 sets, as a start point of the search range 50, a position that is advanced by a total of a first travel distance 51 and a second travel distance 52 from a current location of a host vehicle 15. The first travel distance 51 is a travel distance that is required to bring a speed of the host vehicle 15 to a predetermined safe speed (for example, 10 km/h). The first travel distance 51 can be calculated on the basis of a difference between the current speed of the host vehicle 15 and the safe speed. The second travel distance 52 is a travel distance that is required to cause a direction indicator of the host vehicle 15 to blink for a predetermined blinking time (for example, three seconds). The second travel distance 52 can be calculated on the basis of a product of the safe speed and the blinking time.

<Step ST24>

Next, the evacuation control section 130 determines whether the evacuation place 60 on the road in the travel map data has been set. If the evacuation place 60 has been set, processing in step ST27 is executed. If not, processing in step ST25 is executed.

<Step ST25>

If the evacuation place 60 has not been set, the evacuation control section 130 generates the road information 30 within the search range 50. The generation procedure of the road information 30 is as described above. Next, processing in step ST26 is executed. In this example, the external environment recognition section 111 sequentially updates the integrated map data on the basis of the output of the information acquisition section 7 such as the plural cameras 70, the plural radars 71, and/or the external communication section 75. In the evacuation travel control, the evacuation control section 130 sequentially updates dynamic information (more specifically, the obstacle information 35 and the mobile evaluation information 38) of the road information 30 according to an update of the integrated map data. Here, static information (for example, the width information 33a, the static evaluation information 37, and the like) of the road information 30 is not updated.

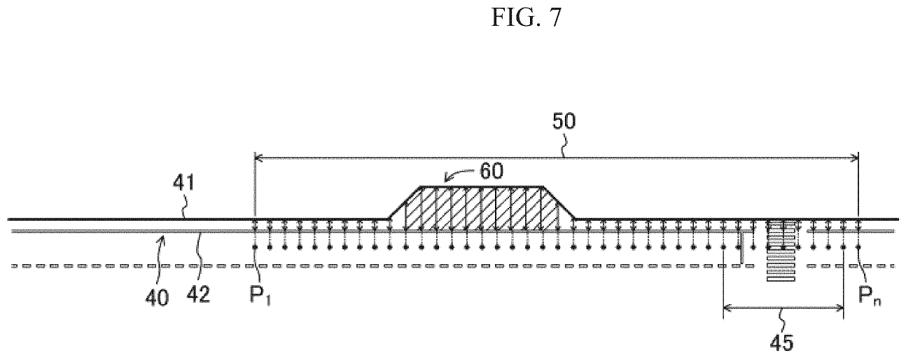

For example, as illustrated in FIG. 7, the evacuation control section 130 sets the number n of the observation points P₁ to Pₙ within the search range 50 and generates the road information 30 indicative of the various types of the information at each of the number n of the observation points P₁ to Pₙ.

<Step ST26>

The evacuation control section 130 sets the evacuation place 60 on the road in the travel map data on the basis of the road information 30 within the search range 50. In this way, the evacuation route for evacuation toward the evacuation place 60 that includes a portion of the road shoulder area 40 is generated, and the travel of the host vehicle is controlled such that the host vehicle travels on the evacuation route.

More specifically, the evacuation control section 130 generates the evacuation route that is a travel route having the evacuation place 60 as a target location. The route determination section 117 sets the evacuation route generated by the evacuation control section 130 as the target route. The vehicle motion determination section 118 determines the target motion corresponding to the evacuation route. The actuator control section 119 controls the operation of the actuator 20 so as to accomplish the target motion corresponding to the evacuation route.

For example, from the road shoulder area 40 within the search range 50, the evacuation control section 130 designates a place where the width information 33a at each of the plural observation points P is continuously acquired for 10 m or longer in the advancing direction of the host vehicle as a candidate place that is a candidate for the evacuation place 60. Next, based on the mobile evaluation information 38 at each of the plural observation points P corresponding to the candidate places, the evacuation control section 130 selects the candidate place where the host vehicle can be stopped. Then, based on the static evaluation information 37 at each of the plural observation points P corresponding to the selected candidate places, the evacuation control section 130 sets the candidate place with the highest evaluation value in the static evaluation information 37 as the evacuation place 60. In the case where the two or more candidate places with the highest evaluation value in the static evaluation information 37 are present, the evacuation control section 130 sets, as the evacuation place 60, the candidate place that is the closest to the current location of the host vehicle of the two or more of the candidate places.

For example, as illustrated in FIG. 7, the evacuation control section 130 sets, as the evacuation place 60, a place having the relatively large width in the road shoulder area 40 within the search range 50. In the example illustrated in FIG. 7, the evacuation place 60 is hatched with diagonal lines from bottom left to top right. In addition, in the example illustrated in FIG. 7, an area including the crosswalk is a stopping prohibition zone 45, and the stopping prohibition zone 45 is not selected as the evacuation place 60.

<Step ST27>

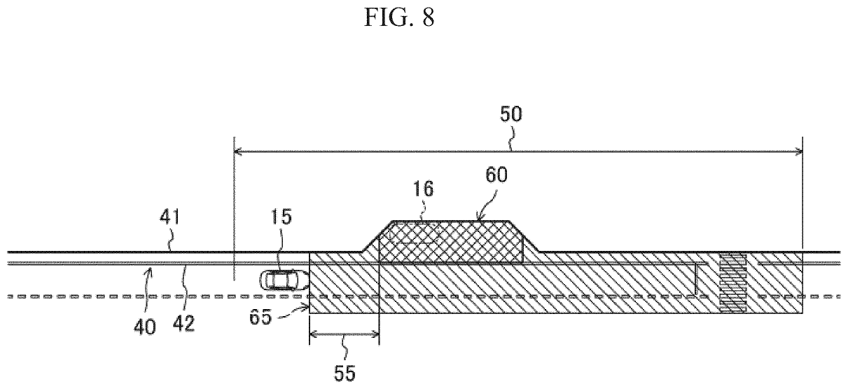

On the other hand, if the evacuation place 60 has been set, the evacuation control section 130 determines whether the host vehicle has reached a determination area 55. As illustrated in FIG. 8, the determination area 55 is an area from a position located rearward from a start position of the evacuation place 60 by a predetermined determination distance to the start position of the evacuation place 60. If the host vehicle has reached the determination area 55, processing in step ST28 is executed. If not, processing in step ST29 is executed.

<Step ST28>

The evacuation control section 130 searches for a free space 65 from the road in the travel map data. For example, the evacuation control section 130 may search for the free space 65 on the basis of the search rule that is set in advance, or may search for the free space 65 on the basis of the learning model generated by deep learning. Then, the evacuation control section 130 determines whether the evacuation place 60 corresponds to the free space 65. If the evacuation place 60 corresponds to the free space 65, the processing in step ST29 is executed. If not, the processing in step ST26 is executed.

For example, as illustrated in FIG. 8, the evacuation control section 130 detects the free space 65 on the road ahead of the host vehicle 15 in the advancing direction. In the example illustrated in FIG. 8, the free space 65 is hatched with diagonal lines from bottom right to top left. In the example illustrated in FIG. 8, a whole area of the evacuation place 60 is set as the free space 65. Thus, the evacuation control section 130 determines that the evacuation place 60 corresponds to the free space 65. In the case where another vehicle 16 is stopped at a location indicated by a two-dot chain line in FIG. 8, not the whole area of the evacuation place 60 is set as the free space 65. Thus, the evacuation control section 130 determines that the evacuation place 60 does not correspond to the free space 65.

<Step ST29>

If the evacuation place 60 corresponds to the free space 65, the evacuation control section 130 maintains the evacuation place 60 without changing the evacuation place 60. In this way, the evacuation route is maintained, and the travel control of the host vehicle is continued such that the host vehicle travels on the evacuation route.

<Step ST30>

In the case where the elapsed time T from the initiation time point of the evacuation travel control exceeds a time threshold value Tth, the evacuation control section 130 sets the nearest place of the host vehicle as the evacuation place 60. In this way, the evacuation route having the nearest place of the host vehicle as the target location is generated, and the travel of the vehicle is controlled such that the host vehicle heads for the nearest place.

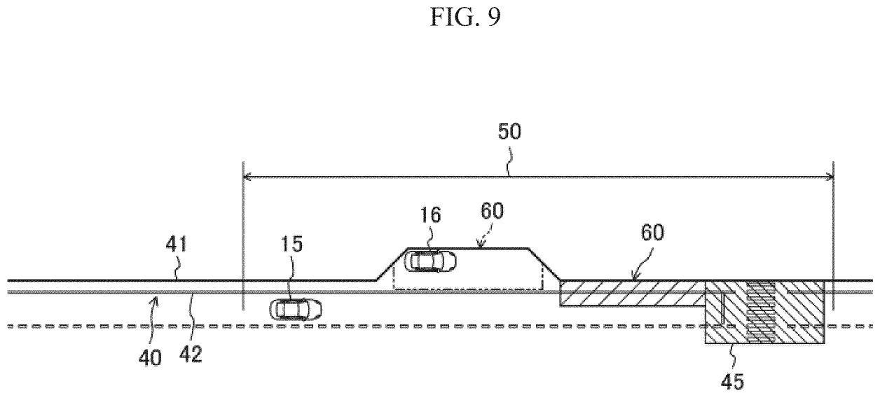

For example, as illustrated in FIG. 9, in the case where the other vehicle 16 is stopped in the evacuation place 60 indicated by a two-dot chain line in FIG. 9, the evacuation control section 130 changes the evacuation place 60 from the place indicated by the two-dot chain line in FIG. 9 to a place hatched with diagonal lines from bottom left to top right in FIG. 9. In addition, in the example illustrated in FIG. 9, an area including the crosswalk (an area hatched with diagonal lines from bottom right to top left) is the stopping prohibition zone 45, and the stopping prohibition zone 45 is not selected as the evacuation place 60.

[Display and Cancellation Switch]

Referring back to FIG. 1, the vehicle control system 1 includes a display D and a cancellation switch 77.

The display D shows the various types of the information in response to the control by the vehicle controller 10. Examples of the display D are a display in a navigation system mounted on the vehicle and a head-mounted display. For example, in the evacuation travel control, the evacuation control section 130 outputs, to the display D, information used to notify that the evacuation travel control is currently executed (evacuation notification information). The display D shows the evacuation notification information that is output from the evacuation control section 130. In this way, it is notified that the evacuation travel control is currently executed.

The cancellation switch 77 is provided to discontinue the evacuation travel control and is operated by an occupant of the vehicle including the driver. For example, in the case where the display D shows the evacuation notification information, and the occupant of the vehicle determines that the driver does not suffer from the abnormal physical condition, the occupant operates the cancellation switch 77. When the cancellation switch 77 is operated by the occupant of the vehicle, the control section 100 discontinues the evacuation travel control. For example, when the cancellation switch 77 is operated, the travel control section 115 stops the control of the actuator 20 that is based on the evacuation route generated by the evacuation control section 130, and starts the control of the actuator 20 that is based on the candidate route generated by the route generation section 116 and the rule-based control section 120. Here, in the case where the cancellation switch 77 is operated, automated driving may be stopped, and manual driving may be started.

### Effects of Embodiment

As it has been described so far, the vehicle controller 10 according to the embodiment can generate the evacuation route in consideration of the width of the road shoulder area 40. More specifically, the evacuation route can be generated in consideration of at least one of the width of the road shoulder area 40 and the margin of the width thereof at each of the plural observation points P. In this way, it is possible to appropriately evacuate the vehicle to the road shoulder area 40.

The vehicle controller 10 according to the embodiment can generate the evacuation route in consideration of which portion of the road shoulder area 40 the vehicle can be stopped in. More specifically, the evacuation route can be generated in consideration of at least one of the presence or the absence of the obstacle at each of the plural observation points P, the correspondence or the non-correspondence of the stopping permission area at each of the plural observation points P, and the possibility or the impossibility of stopping of the vehicle at each of the plural observation points P. In this way, it is possible to appropriately evacuate the vehicle to the road shoulder area 40 by avoiding the portion of the road shoulder area 40 where the vehicle cannot be stopped.

The vehicle controller 10 according to the embodiment generates the real-time road information 30 on the basis of the recognition result of the external environment.

In the case where the abnormal physical condition of the driver of the vehicle is detected, the vehicle controller 10 according to the embodiment executes the evacuation travel control. Thus, in the case where the driver of the vehicle suffers from the abnormal physical condition, it is possible to appropriately evacuate the vehicle to the road shoulder area 40.

As illustrated in FIG. 8, in the case where a place of a bus turnout type (a place with the relatively wide width) in the road shoulder area 40 is set as the evacuation place 60, a curbstone or the like of the road shoulder area 40 possibly becomes a drag. As a result, there is a possibility that it is impossible to check whether the obstacle (for example, the stopped other vehicle 16) is present in the evacuation place 60 until the host vehicle 15 approaches the evacuation place 60. Thus, the information on the obstacle in the evacuation place 60 is desirably and appropriately updated. Meanwhile, it is inefficient to frequently update the static information such as the road structure and the traffic regulation.

In the evacuation travel control, the vehicle controller 10 according to the embodiment sequentially updates the dynamic information (more specifically, the obstacle information 35 and the mobile evaluation information 38) of the road information 30 according to the update of the integrated map data. Here, the static information (for example, the width information 33a, the static evaluation information 37, and the like) of the road information 30 is not updated. As described, when the dynamic information is sequentially updated by separately managing the dynamic information and the static information of the road information 30, it is possible to efficiently update the road information 30.

### Other Embodiments

In the description that has been made so far, in addition to the above function (the control section 100), the vehicle controller 10 may have another function.

In the description that has been made so far, the case where the obstacle information 35 and the mobile evaluation information 38 of the road information 30 are sequentially updated according to the update of the integrated map data has been exemplified. However, the embodiments are not limited thereto. For example, in the evacuation travel control, the evacuation control section 130 may be configured to sequentially update another information of the road information 30 according to the update of the integrated map data in addition to the obstacle information 35 and the mobile evaluation information 38.

In the description that has been made so far, the case where the road information 30 is generated when the abnormal physical condition of the driver is detected has been exemplified. However, embodiments are not limited thereto. For example, the evacuation control section 130 may be configured to generate (update) the road information 30 in each of predetermined cycles, or may be configured to generate the road information 30 in the case where a projection of the abnormal physical condition of the driver is detected.

In the description that has been made so far, the case where the evacuation travel control is initiated when the abnormal physical condition of the driver is detected has been exemplified. However, embodiments are not limited thereto. For example, the evacuation travel control may be initiated with a lapse of a predetermined determination time (for example, 3.2 seconds) from a time point at which the abnormal physical condition of the driver is detected. In this case, it is preferred that the evacuation travel control is not initiated in the case where the cancellation switch 77 is pressed before the lapse of the determination time from the time point at which the abnormal physical condition of the driver is detected. In addition, the evacuation travel control may be executed not only in the case where the abnormal physical condition of the driver is detected but also in other cases. For example, the evacuation travel control may be executed in response to the driver's instruction.

In the description that has been made so far, the case where the mobile evaluation information 38 is generated on the basis of the road condition information 34 and the obstacle information 35 has been exemplified. However, embodiments are not limited thereto. For example, the evacuation control section 130 may be configured to generate the mobile evaluation information 38 on the basis of the classification information 33b and the line type information 33c of the road shoulder area information 33, the road condition information 34, and the obstacle information 35. More specifically, the evaluation value (1 or 0) that is registered in the mobile evaluation information 38 at the k-th number of the observation point Pₖ may be a product of the identification value (1 or 0) that is registered in each of the plural items included in the classification information 33b, the line type information 33c, and the road condition information 34 at the k-th number of the observation point Pₖ and the identification value (1 or 0) that is registered in the obstacle information 35 at the k-th number of the observation point Pₖ.

The following description relates to a computer environment in which embodiments of the present disclosure may be implemented. This environment may include an embedded computer environment, local multi-processor embodiment, remote (e.g., cloud-based) environment, or a mixture of all the environments.

FIG. 10 illustrates a block diagram of a computer that may implement the various embodiments described herein. The present disclosure may be embodied as a system, a method, and/or a computer program product. The computer program product may include a computer readable storage medium on which computer readable program instructions are recorded that may cause one or more processors to carry out aspects of the embodiment.

The non-transitory computer readable storage medium may be a tangible device that can store instructions for use by an instruction execution device (processor). The computer readable storage medium may be, for example, but is not limited to, an electronic storage device, a magnetic storage device, an optical storage device, an electromagnetic storage device, a semiconductor storage device, or any appropriate combination of these devices. A non-exhaustive list of more specific examples of the computer readable storage medium includes each of the following (and appropriate combinations): flexible disk, hard disk, solid-state drive (SSD), random access memory (RAM), read-only memory (ROM), erasable programmable read-only memory (EPROM or Flash), static random access memory (SRAM), compact disc (CD or CD-ROM), digital versatile disk (DVD) and memory card or stick. A computer readable storage medium, as used in this disclosure, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described in this disclosure can be downloaded to an appropriate computing or processing device from a computer readable storage medium or to an external computer or external storage device via a global network (i.e., the Internet), a local area network, a wide area network and/or a wireless network. The network may include copper transmission wires, optical communication fibers, wireless transmission, routers, firewalls, switches, gateway computers and/or edge servers. A network adapter card or network interface in each computing or processing device may receive computer readable program instructions from the network and forward the computer readable program instructions for storage in a computer readable storage medium within the computing or processing device.

Computer readable program instructions for carrying out operations of the present disclosure may include machine language instructions and/or microcode, which may be compiled or interpreted from source code written in any combination of one or more programming languages, including assembly language, Basic, Fortran, Java, Python, R, C, C++, C# or similar programming languages. The computer readable program instructions may execute entirely on a user's personal computer, notebook computer, tablet, or smartphone, entirely on a remote computer or compute server, or any combination of these computing devices. The remote computer or compute server may be connected to the user's device or devices through a computer network, including a local area network or a wide area network, or a global network (i.e., the Internet). In some embodiments, electronic circuitry including, for example, programmable logic circuitry, field-programmable gate arrays (FPGA), or programmable logic arrays (PLA) may execute the computer readable program instructions by using information from the computer readable program instructions to configure or customize the electronic circuitry, in order to perform aspects of the present disclosure.

Aspects of the present disclosure are described herein with reference to flow diagrams and block diagrams of methods, apparatus (systems), and computer program products according to embodiments of the disclosure. It will be understood by those skilled in the art that each block of the flow diagrams and block diagrams, and combinations of blocks in the flow diagrams and block diagrams, can be implemented by computer readable program instructions.

The computer readable program instructions that may implement the systems and methods described in this disclosure may be provided to one or more processors (and/or one or more cores within a processor) of a general purpose computer, special purpose computer, or other programmable apparatus to produce a machine, such that the instructions, which execute via the processor of the computer or other programmable apparatus, create a system for implementing the functions specified in the flow diagrams and block diagrams in the present disclosure. These computer readable program instructions may also be stored in a computer readable storage medium that can direct a computer, a programmable apparatus, and/or other devices to function in a particular manner, such that the computer readable storage medium having stored instructions is an article of manufacture including instructions which implement aspects of the functions specified in the flow diagrams and block diagrams in the present disclosure.

The computer readable program instructions may also be loaded onto a computer, other programmable apparatus, or other device to cause a series of operational steps to be performed on the computer, other programmable apparatus or other device to produce a computer implemented process, such that the instructions which execute on the computer, other programmable apparatus, or other device implement the functions specified in the flow diagrams and block diagrams in the present disclosure.

FIG. 10 is a functional block diagram illustrating a networked system 800 of one or more networked computers and servers. In an embodiment, the hardware and software environment illustrated in FIG. 10 may provide an exemplary platform for implementation of the software and/or methods according to the present disclosure.

Referring to FIG. 10, a networked system 800 may include, but is not limited to, computer 805, network 810, remote computer 815, web server 820, cloud storage server 825 and computer server 830. In some embodiments, multiple instances of one or more of the functional blocks illustrated in FIG. 8 may be employed.

Additional detail of computer 805 is shown in FIG. 10. The functional blocks illustrated within computer 805 are provided only to establish exemplary functionality and are not intended to be exhaustive. And while details are not provided for remote computer 815, web server 820, cloud storage server 825 and compute server 830, these other computers and devices may include similar functionality to that shown for computer 805.

Computer 805 may be built into the automobile, a personal computer (PC), a desktop computer, laptop computer, tablet computer, netbook computer, a personal digital assistant (PDA), a smart phone, or any other programmable electronic device capable of communicating with other devices on network 810.

Computer 805 may include processor 835, bus 837, memory 840, non-volatile storage 845, network interface 850, peripheral interface 855 and display interface 865. Each of these functions may be implemented, in some embodiments, as individual electronic subsystems (integrated circuit chip or combination of chips and associated devices), or, in other embodiments, some combination of functions may be implemented on a single chip (sometimes called a system on chip or SoC).

Processor 835 may be one or more single or multi-chip microprocessors, such as those designed and/or manufactured by Intel Corporation, Advanced Micro Devices, Inc. (AMD), Arm Holdings (Arm), Apple Computer, etc. Examples of microprocessors include Celeron, Pentium, Core i3, Core i5 and Core i7 from Intel Corporation; Opteron, Phenom, Athlon, Turion and Ryzen from AMD; and Cortex-A, Cortex-R and Cortex-M from Arm.

Bus 837 may be a proprietary or industry standard high-speed parallel or serial peripheral interconnect bus, such as ISA, PCI, PCI Express (PCI-e), AGP, and the like.

Memory 840 and non-volatile storage 845 may be computer-readable storage media. Memory 840 may include any suitable volatile storage devices such as Dynamic Random Access Memory (DRAM) and Static Random Access Memory (SRAM). Non-volatile storage 845 may include one or more of the following: flexible disk, hard disk, solid-state drive (SSD), read-only memory (ROM), erasable programmable read-only memory (EPROM or Flash), compact disc (CD or CD-ROM), digital versatile disk (DVD) and memory card or stick.

Program 848 may be a collection of machine readable instructions and/or data that is stored in non-volatile storage 845 and is used to create, manage and control certain software functions that are discussed in detail elsewhere in the present disclosure and illustrated in the drawings. In some embodiments, memory 840 may be considerably faster than non-volatile storage 845. In such embodiments, program 848 may be transferred from non-volatile storage 845 to memory 840 prior to execution by processor 835.

Computer 805 may be capable of communicating and interacting with other computers via network 810 through network interface 850. Network 810 may be, for example, a local area network (LAN), a wide area network (WAN) such as the Internet, or a combination of the two, and may include wired, wireless, or fiber optic connections. In general, network 810 can be any combination of connections and protocols that support communications between two or more computers and related devices.

Peripheral interface 855 may allow for input and output of data with other devices that may be connected locally with computer 805. For example, peripheral interface 855 may provide a connection to external devices 860. External devices 860 may include input devices, e.g., any or all of the devices in the information acquisition means 10 and/or other suitable input devices, and output devices, e.g., any or all of the various actuator devices AC and/or other suitable output devices, e.g., a speaker. External devices 860 may also include portable computer-readable storage media such as, for example, thumb drives, portable optical or magnetic disks, and memory cards. Software and data used to practice embodiments of the present disclosure, for example, program 848, may be stored on such portable computer-readable storage media. In such embodiments, software may be loaded onto non-volatile storage 845 or, alternatively, directly into memory 840 via peripheral interface 855. Peripheral interface 855 may use an industry standard connection, such as RS-232 or Universal Serial Bus (USB), to connect with external devices 860.

Display interface 865 may connect computer 805 to display 870, e.g., a head-up display or a screen of a car navigation system. Display 870 may be used, in some embodiments, to present a command line or graphical user interface to a user of computer 805. Display interface 865 may connect to display 870 using one or more proprietary or industry standard connections, such as VGA, DVI, DisplayPort and HDMI.

As described above, network interface 850, provides for communications with other computing and storage systems or devices external to computer 805. Software programs and data discussed herein may be downloaded from, for example, remote computer 815, web server 820, cloud storage server 825 and compute server 830 to non-volatile storage 845 through network interface 850 and network 810. Furthermore, the systems and methods described in this disclosure may be executed by one or more computers connected to computer 805 through network interface 850 and network 810. For example, in some embodiments the systems and methods described in this disclosure may be executed by remote computer 815, computer server 830, or a combination of the interconnected computers on network 810.

Data, datasets and/or databases employed in embodiments of the systems and methods described in this disclosure may be stored and or downloaded from remote computer 815, web server 820, cloud storage server 825 and compute server 830.

The embodiments that have been so far may appropriately be combined and implemented. The embodiment that has been described so far is essentially and merely illustrative and thus has no intention to limit the scopes of the present invention, application subjects thereof, and application thereof.

1. A vehicle controller that controls a vehicle, the vehicle controller comprising:
circuitry configured to:
generate an evacuation route for evacuating the vehicle to the road shoulder area on the basis of road information, and
control travel of the vehicle such that the vehicle travels on the evacuation route, wherein the road information includes first information on a width of a road shoulder area along an end of the road in a width direction.

2. The vehicle controller according to claim 1, wherein
the first information includes at least one of width information indicative of the width of the road shoulder area at each of plural observation points aligned in the advancing direction of the vehicle and static evaluation information indicative of a margin of the width of the road shoulder area at each of the plural observation points.

3. The vehicle controller according to claim 2, wherein
the road information includes second information indicative of which portion of the road shoulder area the vehicle can be stopped in.

4. The vehicle controller according to claim 3, wherein
the second information includes at least one of obstacle information indicative of presence or absence of an obstacle in the road shoulder area at each of the plural observation points aligned in the advancing direction of the vehicle, road condition information indicative of whether the road shoulder area corresponds to a stopping permission area at each of the plural observation points, and mobile evaluation information indicative of whether the vehicle can be stopped in the road shoulder area at each of the plural observation points.

5. The vehicle controller according to claim 4, wherein circuitry is configured to:
recognize an external environment of the vehicle, generate the road information on the basis of a recognition result of the external environment, and store the road information in the memory.

6. The vehicle controller according to claim 5, wherein
circuitry is configured to execute the evacuation travel control an abnormal physical condition of a driver of the vehicle is detected.

7. The vehicle controller according to claim 4, wherein
circuitry is configured to execute the evacuation travel control an abnormal physical condition of a driver of the vehicle is detected.

8. The vehicle controller according to claim 3, wherein circuitry is configured to:
recognize an external environment of the vehicle, generate the road information on the basis of a recognition result of the external environment, and store the road information in the memory.

9. The vehicle controller according to claim 3, wherein
circuitry is configured to execute the evacuation travel control an abnormal physical condition of a driver of the vehicle is detected.

10. The vehicle controller according to claim 2, wherein circuitry is configured to:
recognize an external environment of the vehicle, generate the road information on the basis of a recognition result of the external environment, and store the road information in the memory.

11. The vehicle controller according to claim 2, wherein
circuitry is configured to execute the evacuation travel control an abnormal physical condition of a driver of the vehicle is detected.

12. The vehicle controller according to claim 1, wherein
the road information includes second information indicative of which portion of the road shoulder area the vehicle can be stopped in.

13. The vehicle controller according to claim 12, wherein
the second information includes at least one of obstacle information indicative of presence or absence of an obstacle in the road shoulder area at each of the plural observation points aligned in the advancing direction of the vehicle, road condition information indicative of whether the road shoulder area corresponds to a stopping permission area at each of the plural observation points, and mobile evaluation information indicative of whether the vehicle can be stopped in the road shoulder area at each of the plural observation points.

14. The vehicle controller according to claim 12, wherein circuitry is configured to:
recognize an external environment of the vehicle, generate the road information on the basis of a recognition result of the external environment, and store the road information in the memory.

15. The vehicle controller according to claim 12, wherein
circuitry is configured to execute the evacuation travel control an abnormal physical condition of a driver of the vehicle is detected.

16. The vehicle controller according to claim 1, wherein circuitry is configured to:
recognize an external environment of the vehicle, generate the road information on the basis of a recognition result of the external environment, and store the road information in the memory.

17. The vehicle controller according to claim 16, wherein
circuitry is configured to execute the evacuation travel control an abnormal physical condition of a driver of the vehicle is detected.

18. The vehicle controller according to claim 1, wherein
circuitry is configured to execute the evacuation travel control an abnormal physical condition of a driver of the vehicle is detected.

19. A method of controlling a vehicle, the method comprising:
obtaining information on a road ahead of the vehicle in an advancing direction;
generating an evacuation route for evacuating the vehicle to the road shoulder area on the basis of the road information, wherein the road information includes first information on a width of a road shoulder area along an end of the road in a width direction; and
controlling travel of the vehicle such that the vehicle travels on the evacuation route.

20. A non-transitory computer readable storage including computer readable instructions that when executed by a controller cause the controller to execute a method of controlling a vehicle, the method comprising: obtaining information on a road ahead of the vehicle in an advancing direction;
generating an evacuation route for evacuating the vehicle to the road shoulder area on the basis of the road information, wherein the road information includes first information on a width of a road shoulder area along an end of the road in a width direction; and
controlling travel of the vehicle such that the vehicle travels on the evacuation route.
